(19) United States
(12) Patent Application Publication
(10) Pub. No.: US 2025/0115079 A1
(43) Pub. Date: Apr. 10, 2025

(54) NON-PNEUMATIC HOLLOW TIRE AND MANUFACTURING METHOD

(71) Applicant: TIANJIN WANDA TYRE CO., LTD., Tianjin (CN)

(72) Inventors: Peng GENG, Tianjin (CN); Qinghua ZHANG, Tianjin (CN); Chuan LIU, Tianjin (CN); Guili XIE, Tianjin (CN)

(21) Appl. No.: 18/420,966

(22) Filed: Jan. 24, 2024

(30) Foreign Application Priority Data
Oct. 9, 2023 (CN) 202311296411.5

(51) Int. Cl. B60C 7/22

(52) U.S. Cl. CPC B60C 7/22

(57) ABSTRACT

A non-pneumatic hollow tire includes a tire body, a spiral channel is defined in the tire body, the spiral channel is through from a head end to a tail end. The manufacturing method of the non-pneumatic hollow tire with this structure includes: winding a strip with through hole in a stacked manner in a plurality of layers to form a structure in the tire cavity, then curing it to complete the non-pneumatic hollow tire.

### CROSS-REFERENCE TO RELATED APPLICATION

This application claims the priority and benefit of Chinese patent application serial no. 202311296411.5, filed on Oct. 9, 2023. The entirety of Chinese patent application serial no. 202311296411.5 is hereby incorporated by reference herein and made a part of this specification.

### TECHNICAL FIELD

The disclosure relates to the technical field of tire, and relates to tire structures and processing methods, and in particular, to a non-pneumatic hollow tire and a manufacturing method.

### BACKGROUND ART

Currently, the tire with non-pneumatic hollow tire structure on the market is configured with a plurality of annular channels, but the channels are not in communication with each other. Different pressures are generated in the channels inside the tire by running, which can easily produce a “flat spot”, so that the handling and driving stability of the vehicle is affected. The existing non-pneumatic tire manufacturing process is to butt/overlap rubber strips with one or more through holes end to end into a circle, and then vulcanize them to form a tire product. However, due to the rubber accumulation at the overlapping position of the rubber strips, the thickness of the finished tire will be uneven after vulcanization, which will lead to a poor runout of the finished tire. In addition, the finished tire has a low strength and is prone to cracking at the overlapping position. Secondly, during the process of bending the rubber strip into a circle or during the vulcanization process, the channel diameter in the tire is changed, which causes nonuniform distribution of the channel diameter in the finished tire and further causes a poor tire runout, thereby affecting the driving comfort of the vehicle and reducing the service life of the tire.

After searching, the following published patent technologies were found:

Patent document CN115042562A discloses a non-pneumatic tire, which includes a tread in contact with the ground, a rim in connection with the axle, and a spoke between the rim and the tread to provide a structural support. The above-mentioned spoke is formed by a meta-structure formed by repeating a unit structure. Through this technical solution the support to the load near the surface in contact with the ground and the surface connected to the axle is enhanced, which can enhance the supporting force on the ground and improve the ability to gently absorb various impacts. The technical problem solved by this solution is different from the technical problem to be solved by the present disclosure, so the proposed technical solution itself is completely different from that of the present disclosure. In addition, this patent document does not disclose the manufacturing method, but since the structure is completely different, it can be deduced that the manufacturing method is completely different from that of the present disclosure.

Patent document CN109466251B discloses another non-pneumatic tire that includes an inner annular portion and an outer annular portion arranged concentrically, and a plurality of first connection portions and a plurality of second connection portions which connect the inner annular portion and the outer annular portion and are alternately arranged in parallel in the circumferential direction of the tire. It is intended to provide a non-pneumatic tire that can simultaneously achieve ride comfort and durability. The technical problem solved by this solution is different from the technical problem to be solved by the present disclosure, so the proposed technical solution itself is completely different from that of the present disclosure. This patent document does not disclose the manufacturing method, but since the structure is completely different, it can be deduced that the manufacturing method is completely different from that of the present disclosure.

To sum up, the documents of existing technique can not affect the inventiveness of the technical solution of the present disclosure.

### SUMMARY

In order to solve the problems in the existing technique, the present disclosure provides a non-pneumatic hollow tire and a manufacturing method. The non-pneumatic hollow tire of the present disclosure has an excellent circumferential uniformity and comfort performance. Its rubber material has no joints and a uniform thickness.

A non-pneumatic hollow tire includes a tire body, a spiral channel is defined in the tire body, the spiral channel is through from a head end to a tail end.

According to the above technical solution, the non-pneumatic hollow tire of this structure is configured with a long spiral inner channel that is through from end to end. An inner cavity of the channel is through to ensure that the pressure inside the channel is always balanced and the pressure of the tire is uniform during running, so that the tire operation performance is reliable. The overall thickness of the tire is uniform, and the tire has a good circumferential uniformity, which ensures the vehicle driving comfort and stability.

Optionally, the spiral channel is laid in a continuously stacked manner, to form a cylindrical spiral structure, and the spiral channel has a uniform pitch, a uniform channel diameter and a uniform cross-section shape.

According to the above technical solution, the channel is evenly distributed in the circumferential direction. The cylindrical structure formed therefrom is matched with the tire body structure. The channel is configured to have exactly constant pitch, channel diameter and channel cross-section shape, to ensure that the channel is evenly distributed in the circumferential direction of the tire, so that the pressure in the channel is distributed in the interconnected circumferential circles in a balanced way, thereby maintaining the good circumferential uniformity of the tire and obtaining a good comfort and stability when running.

Optionally, the spiral channel is laid in a plurality of layers, the spiral channel has different or not exactly a uniform pitch, channel diameter and cross-section shape in different layers of the plurality of layers, and the spiral channel has a uniform pitch, channel diameter and cross-section shape in a same layer of the plurality of layers.

According to the above technical solution, the channel can be configured to have different or not exactly the uniform pitch, channel diameter and shape in different layers according to the design needs of the tire, but it is necessary to ensure that the channel has the uniform pitch, channel diameter and shape in the same layer, which can also ensure a good circumferential uniformity of the tire.

Optionally, the head end and the tail end of the spiral channel are enclosed in a tire cavity, or one or both of the head end and the tail end of the spiral channel is in communication with an outside of the tire body.

According to the above technical solution, whether the channel is in communication with the outside or not can be selected according to the application situation of the tire. When the head end and tail end of the channel are enclosed in the tire cavity, it can ensure that the inside of the channel is closed, such that the air pressure in the channel can remain stable, and the overall support strength of the tire is high. The structural design that the channel end is in communication with the outside facilitates the discharge of the internal pressure, so that the deformation of the tire is greater, which has a better comfort, however, by which a higher elastic recovery ability of the shape of the channel is required, by which a channel wall material with higher elasticity can be selected to be adapted to the structural setting.

Optionally, a channel wall of the channel is made of one or more materials selected from rubber, PU, TPV, TPU, resin composite, fiber composite, metal, steel wire and nylon.

According to the above technical solution, a channel wall is added to the channel as a supporting structure. The channel wall is closely attached to the inner wall of the channel in the tire cavity, and the thickness of the channel wall and the supporting force at each position in the channel are uniform. With the channel wall is provided, the structure stability inside the channel during the preparation process can be ensured, therefore the channel is not easily deformed. The material of the channel wall can be a material that is fused with the tire, so that the cured channel wall and the tire are integrated. A material that is not fused with the tire body can also be selected. The channel wall improves the supporting force of the channel and the recovery ability after the pressure is released, so as to further improve damping property of the tire, and in turn improve the running comfort of the tire.

Optionally, a cross section of the spiral channel is circular, elliptical, triangular or polygonal.

According to the above technical solution, the shape of the channel itself is not limited to a certain definite shape. An optimal channel shape can be selected according to the size and structural design of the tire. The pattern of the channel is designed according to the tire structure and can be configured as a regular pattern or any irregular pattern. It is only necessary to ensure the balance of the supporting force of the tire, so as to ensure that the tire has a better circumferential uniformity.

A manufacturing method for non-pneumatic hollow tire included the following steps:
Step 1: preparing a strip, an inner hole through the strip from end to end is defined in the strip;
Step 2: winding the strip in the circumferential direction of the tire, to form a strip layer as the blank for preparing the tire cavity in the tire body;
Step 3: coating a rubber sheet outside the strip layer, and then placing them in a mold for curing, or placing the strip layer directly in the mold, then injecting material of the tire body into the mold for curing, so as to form a non-pneumatic hollow tire.

According to the above technical solution, the tire manufactured by this method is formed with strip that is spirally wound regularly in a stacked manner. It is not necessary to overlap the strips and therefore no joints is generated, which avoids the disadvantages of low strength and easy cracking at the joints of the finished tire in the existing technology, thereby ensuring the service life of the tire, and which overcomes the problem of rubber accumulation in the existing technology, which will cause uneven thickness of the finished tire after vulcanization and lead to poor runout of the finished tire.

Optionally, in the Step 1,
the strip is formed in one piece, in which an inner hole is formed, the inner hole is through from end to end; or
the strip is made of a group of sub-strips, and the group of sub-strips is formed by a plurality of identical separate sub-strips side by side; or
the strip is formed in one piece, a group of through holes are formed in the strip, and the group of through holes comprises two or more inner holes, the two or more inner holes are through from end to end.

According to the above technical solution, one of the above forms of the strip can be selected according to the tire design to manufacture the non-pneumatic hollow tire of the disclosure, through which a good circumferential uniformity required by the design can be achieved.

Optionally, the inner hole/each of the two or more inner holes has a uniform channel diameter and shape from end to end, or the inner hole/each of the two or more inner holes is segmented to have different channel diameters and/or different shapes corresponding to channel positions in different strip layers of the group of strip layers, and the inner hole/each of the two or more inner holes has a uniform size and a uniform shape at a same strip layer of the group of strip layers.

According to the above technical solution, the strip in this production method can be pre-segmented according to the design requirements to set the channel diameter and shape of the inner channel, so as to produce a channel structure with the same or different channel diameters and shapes in different strip layers.

In a manufacturing method for non-pneumatic hollow tires, any of the above-mentioned non-pneumatic hollow tires can be directly produced with traditional vulcanization, PU casting or 3D printing methods.

According to the above technical solution, the manufacturing method of the structure of the non-pneumatic hollow tire in this disclosure is not limited to the traditional tire vulcanization and curing method. It can also be directly manufactured and formed with methods such as PU casting or 3D printing. The formed structure can ensure that the tire has a better circumferential uniformity.

In summary, the disclosure includes at least one of the following beneficial technical effects:

1. According to the technical solution of this disclosure, a strip with through hole is wound in a stacked manner in a plurality of layers to form a complete tire body, such that the overall thickness of the tire structure is uniform and the tire has a good circumferential uniformity, so as to ensure the driving comfort and stability of the vehicle.

2. The tires produced by the technical solution of this disclosure have no joints, which avoids the problems of low local strength and cracking, thereby ensuring the service life of the tires.

3. The inner hole of the tire structure are through from end to end in the technical solution of this disclosure, which provides a good comfort and stability when running.

4. The present manufacturing method can also be applied to manufacture solid tires or non-pneumatic tires with porous intermediate layer, thereby having a good spreading value.

### BRIEF DESCRIPTION OF THE DRAWINGS

FIG. 1 is a perspective view of the non-pneumatic hollow tire according to an embodiment.

FIG. 2 is a schematic longitudinal cross-section view.

FIG. 3 is a schematic lateral cross-section view of the tire of embodiment 1.

FIG. 4 is a schematic lateral cross-section view of the tire of embodiment 2.

FIG. 5 is a schematic lateral cross-section view of the tire of embodiment 3.

FIG. 6 is a schematic lateral cross-section view of the tire of embodiment 4.

### DETAILED DESCRIPTION

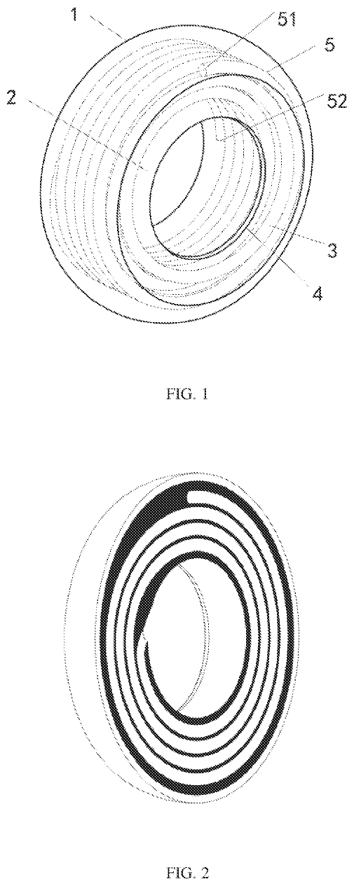

The disclosure will be described in further detail below with reference to FIGS. 1-6. The drawings are for illustrative purposes only and should not be construed as limitations of this patent. In order to better illustrate the embodiments, some components of the drawings will be omitted, enlarged or reduced, which does not represent the size of the actual product. It is understandable for those skilled in the art that some known structures in the drawings and their descriptions are omitted. The positional relationships described in the drawings are for illustrative purposes only.

### Embodiment 1

As shown in FIG. 1, the disclosure provides a non-pneumatic hollow tire, which includes a tire body. The tire body includes a tread 1, sidewalls 2, a tire cavity 3 and a bead 4. The tread 1 is an outer circumferential surface of the tire body. The radial inner sides of both axial ends of the tread 1 are provided with the sidewalls 2 in the circumferential direction. The bead 4 is arranged on the radial inner circumferences of the sidewalls 2. The bead 4 is configured to abut against the hub;

The annular cavity enclosed by the tread 1 and the sidewalls 2 is the tire cavity 3. A channel 5 is defined in the tire cavity 3. The channel 5 is of a cylindrical spiral structure including a plurality of spiral coils that are continuously stacked. The pitch of the spiral coils is the same. A head end 51 and a tail end 52 of the channel 5 are respectively configured at the circumferential positions of the tire cavity 3 corresponding to the spiral coils at two axial ends.

The channel 5 is through from the head end 51 to the tail end 52. The air pressure in the channel 5 is uniform, so that the pressure inside the tire is always evenly dispersed when running, so as to ensure the running stability and comfort of the tire. Moreover, the channel 5 has the uniform channel diameter and shape from the head end 51 to the tail end 52, which is more conducive to ensuring the uniform distribution of the pressure in the tire.

The drawings in this embodiment show that the cross section of the channel 5 is circular, which can also be designed as an ellipse, a triangle, a polygon or other irregular shapes as needed. The connectivity of the channel is maintained from the head end 51 to the tail end 52 to ensure a uniform pressure distribution in the tire.

The channel 5 of cylindrical spiral structure in the tire cavity 3 is configured to have a continuous single-layer structure or a continuous multiple-layer structure. The spiral passage formed by the channel is wound in the circumferential direction at first to form a layer of spiral structure with uniform pitch, and then is wound layer by layer on the outer layer of the first layer of spiral structure. The channel 5 is defined at the intermediate layer of the tire cavity 3, or can also be defined at the outer layer of the tire cavity 3 close to the tread 1.

As shown in FIG. 1, the head end 51 and the tail end 52 of the channel 5 can be both enclosed in the tire cavity 3. When the tire is squeezed, a larger air pressure is maintained in the channel 5, which is suitable for tires that require stronger supporting force.

As shown in FIG. 2, one or both of the head end 51 and the tail end 52 of the channel 5 is/are in communication with the outside of the tire body. When the tire is squeezed, the air in the channel 5 is discharged, which is suitable for tires that require better deformability.

As shown in FIG. 3, the channel 5 with cylindrical spiral structure of the tire cavity 3 is wound to form two or more layers. The channel 5 is of a multiple-layer structure of channel 5 concentrically arranged at equal intervals from the inside to the outside. The internal channels are all connected, to ensure a uniform pressure in the circumferential direction of the tire. In the radial cross-section of the tire in the tire cavity, the channel 5 is arranged in an array evenly spaced in the transverse direction and longitudinal direction.

### Embodiment 2

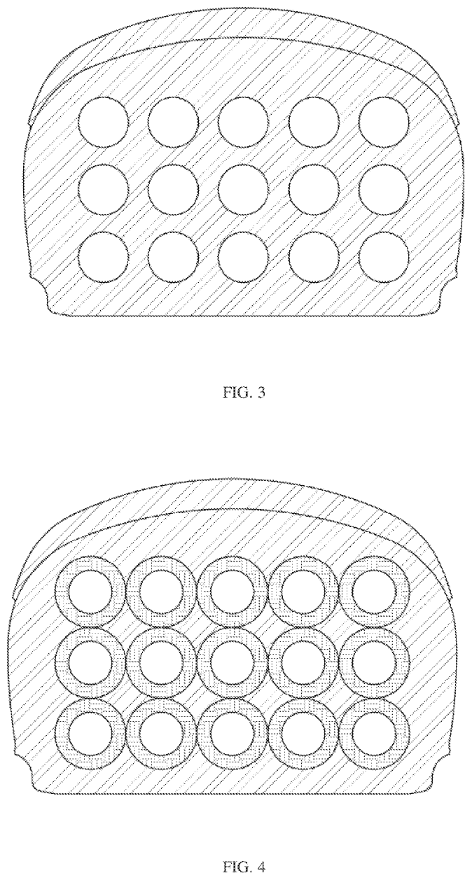

As shown in FIG. 4, this embodiment differs from embodiment 1 in that the inner wall of the channel 5 is configured with a channel wall. The channel wall can be made of one or more materials selected from the group consisting of rubber, PU, TPV, TPU, resin composite material, fiber composite material, metal, steel wire, nylon, chemical additives etc. Through the channel wall the supporting force of the channel 5 can be enhanced, which further improves the damping property of the tire, and thereby improving the ride comfort of the tire.

The specific structure is that the inner wall of the channel 5 of the tire cavity 3 is evenly configured with a channel wall. The channel wall is closely attached to the inner wall of the channel 5 in the tire cavity 3. The thickness of the channel wall is uniform at each position. The channel 5 with communicated inner cavity is formed inside the channel wall. With the channel wall the internal structure of the channel 5 can be stable during the manufacturing process and is not easily deformed, and the supporting force of the channel 5 and the recovery ability of the channel after the pressure is relieved can be ensured.

In a radial cross-section of the tire in the tire cavity 3, the channel 5 is arranged in a transversely aligned array evenly and closely arranged in the transverse and longitudinal directions.

### Embodiment 3

This embodiment differs from embodiments 1 and 2 in that the channel 5 is symmetrically arranged on both sides of the center line of the tire cavity 3. The channel 5 is laid in a staggered, progressively increasing or progressively decreasing manner on both sides. The lay-out of the channel 5 can be configured according to the tire design requirements and the tire cavity structure, such as a circular, square, polygonal, irregular pattern, etc. It is necessary to ensure that the loading capacity of both lateral sides of the tire is the same and is uniformly distributed in the circumferential direction.

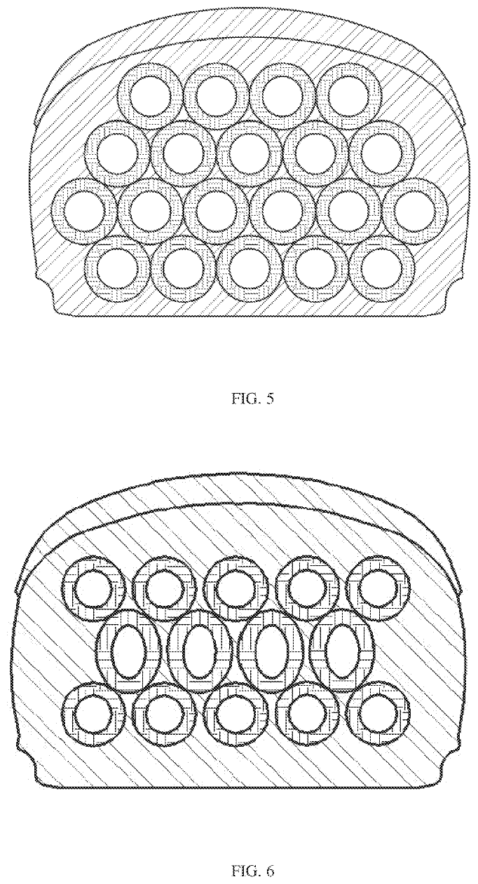

As shown in FIG. 5, the holes on both sides of the center line of the tire cavity 3 are arranged in an array structure, the width of which increases layer by layer from the top to the middle, and then decreases layer by layer from the middle to the bottom. The holes on both sides of the center line of the tire cavity 3 are symmetrically arranged. The centers of some of the holes can be configured at the center line of the tire cavity 3.

### Embodiment 4

As shown in FIG. 6, the channel is laid according to the tire structure. The channel in the tire cavity 3 are designed in multiple-layer. The channel has different channel diameter or different shapes in different layers. At the same time, the channel can have different pitches in different layers. The channel shall have a uniform pitch, channel diameter and shape in the same layer to ensure a better uniformity in the circumferential direction.

### Embodiment 5

The embodiment differs from embodiment 1 in the spiral form of the channel 5. Particularly, the channel rotates in a circumferential direction at first to form a disk-shaped spiral layer formed by an involute spiral structure with equal pitch, and then wounded in a stacked manner layer by layer.

The spiral form of the channel in this disclosure includes, but is not limited to, the cylindrical spiral structure formed by spiral coils with equal pitch disclosed in embodiment 1, or the disc-shaped spiral structure formed by involute spirals with equal pitch disclosed in embodiment 3. Other spiral forms not mentioned in these embodiments, such as spiral structures with unequal pitches, can also be included.

The manufacturing method of non-pneumatic hollow tire structure in this implementation is as follows:

Step 1: preparing a strip, an inner hole through the strip from end to end is defined in the strip. The outer wall shape, the inner hole shape, the size and the material of the strip are determined according to the design requirements.

Optionally, the strip is formed in one-piece, and an inner hole through the strip from end to end is defined therein. The inner hole can be configured to have a uniform channel diameter and shape from end to end, or can be segmented to have different channel diameters and different shapes at positions corresponding to different layers of channel according to design requirements.

Optionally, the strip is a group of sub-strips composed of a plurality of identical separate sub-strips as mentioned, which are arranged in parallel. The width of pattern formed by the group of sub-strips is consistent with the width of the bottom layer of the tire. Then the group of sub-strips are wound in the circumferential direction of the tire together, to form the tire body.

Optionally, the strip is a single strip with a group of through holes therein. The group of through holes includes two or more inner holes running through from end to end. The arrangement of the group of through holes includes, but is not limited to lateral and/or parallel arrangement. The inner holes of the group of through holes can be configured to have the uniform hole diameter and shape from end to end, or can be segmented to have different shapes or different hole diameters at positions corresponding to different layers of channel according to design requirements.

Step 2: Winding the strip in the circumferential direction of the tire, to form a strip layer as the blank for preparing the tire cavity, or continuously winding the strip in a stacked manner in the circumferential direction of the tire, to form a group of strip layer consisting of a plurality of strip layers as the blank for preparing the tire cavity.

Optional method for specific winding the group of strips include:
(1) continuously winding the strip in the circumferential direction according to the set size of the tire cavity, to form a cylindrical first strip layer at first, then continuously winding the strip in an opposite circumferential direction on the outer circumference of the first strip layer, to form a second strip layer, and so on, sequentially stacking to form a group of strip layers matched with the tire cavity, the channel structure as disclosed in embodiment 1 will be formed in the tire cavity;
(2) winding the strip from an axial position from inside to outside, to form a disc-shaped first strip layer, then winding the strip from outside to inside on one side of the first strip layer, to form a second strip layer, and so on, sequentially stacking to form a group of strip layers matched with the tire cavity.

Step 3: Coating a rubber sheet outside the group of strip layers, and then placing them in a mold for curing, or placing the group of strip layers directly in the mold, then injecting the material of the tire body such as rubber/PU into the mold for curing, so as to form a tire product, and completing the manufacturing of the non-pneumatic hollow tire.

Optionally, the material of the outer wall of the strip may or may not be fused with the tire body. If a material of the hole wall that can be fused with the tire body is selected, the hole wall becomes a part of the tire after curing. If a material of channel wall that is not fused with the tire body is selected, the channel wall material will be extracted after curing.

With this manufacturing method, the problems of low strength and easy cracking at the tread overlap point in the existing technology can be effectively avoided, the overall rubber material of the tire is evenly distributed, so as to ensure a good circumferential uniformity and extend the service life of the tire.

In addition, traditional vulcanization, PU casting, 3D printing and other methods can be used to manufacture the product of this disclosure.

In addition, this manufacturing method can also be applied to solid tires. In particular, strip without inner hole is used to be wound in a stacked manner in a plurality of layers, to form a complete blank for tire body, the preparation of a non-pneumatic solid tire will be completed after curing. The rubber material is evenly distributed to avoid the problem of low strength and easy cracking at the surface overlap point.

In addition, this manufacturing method is also applicable to the non-pneumatic tire with porous intermediate layer. The specific steps are the same as the manufacturing method in this embodiment.

The above-mentioned embodiments of the disclosure are merely examples to clearly illustrate the disclosure, and are not intended to limit the implementation of the disclosure. For those of ordinary skill in the art, other different forms of changes or modifications can be made based on the above description. An exhaustive list of all implementations is neither necessary nor possible. Any modifications, equivalent substitutions and improvements made within the spirit and principles of the disclosure shall fallen in the protection scope of the disclosure.

### LIST OF REFERENCE SIGNS

1 tread
2 sidewall
3 tire cavity
4 bead
5 channel
51 head end
52 tail end

What is claimed is:

1. A non-pneumatic hollow tire, comprising a tire body, wherein a spiral channel is defined in the tire body, the spiral channel extends from a head end to a tail end.

2. The non-pneumatic hollow tire according to claim 1, wherein the spiral channel is laid in a continuously stacked manner to form a cylindrical spiral structure, and the spiral channel has a uniform pitch, a uniform channel diameter and a uniform cross-section shape.

3. The non-pneumatic hollow tire according to claim 1, wherein the spiral channel is laid in a plurality of layers, the spiral channel has different pitches, channel diameters and cross-section shapes in different layers of the plurality of layers, and the spiral channel has a uniform pitch, channel diameter and cross-section shape in a same layer of the plurality of layers.

4. The non-pneumatic hollow tire according to claim 1, wherein the head end and the tail end of the spiral channel are enclosed in a tire cavity, and or one or both of the head end and the tail end of the spiral channel is in communication with an outside of the tire body.

5. The non-pneumatic hollow tire according to claim 1, wherein a channel wall of the spiral channel is made of one or more materials selected from rubber, resin composite material and metal.

6. The non-pneumatic hollow tire according to claim 1, wherein a cross section of the spiral channel is circular, elliptical, triangular or polygonal.

7. The non-pneumatic hollow tire according to claim 1, wherein:
the spiral channel is an inner hole in a strip, the inner hole extends from end to end of the strip, the strip is wound in a circumferential direction of the non-pneumatic hollow tire to form a group of strip layers as a blank for a tire cavity in the tire body, and one of:
a rubber sheet is coated outside the group of strip layers, then the group of strip layers with the rubber sheet is placed in a mold for curing, or
the group of strip layers is directly placed in the mold, and then a material of the tire body is injected into the mold for curing, so as to form the non-pneumatic hollow tire.

8. The non-pneumatic hollow tire according to claim 7, wherein
the strip is formed in one piece, the inner hole is formed in the strip, and the inner hole extends from end to end of the strip; or
the strip is made of a group of sub-strips, the group of sub-strips is formed by a plurality of separate sub-strips side by side, and each of the plurality of separate sub-strips is configured with the inner hole; or
the strip is formed in one piece, a group of through holes are formed in the strip, the group of through holes comprises two or more inner holes, the two or more inner holes extend end to end of the strip.

9. The non-pneumatic hollow tire according to claim 8, wherein:
the inner hole or each of the two or more inner holes has a constant channel diameter and shape from end to end of the strip, or
the inner hole or each of the two or more inner holes is segmented to have at least one of different channel diameters or different shapes corresponding to channel positions in different strip layers of the group of strip layers, and the inner hole or each of the two or more inner holes has a same size and a same shape in a same strip layer of the group of strip layers.
